(19) United States
(12) Patent Application Publication
(10) Pub. No.: US 2008/0006991 A1
(43) Pub. Date: Jan. 10, 2008

(54) Ejection sheet stacker

(75) Inventors: Masaharu Kimura, Osaka (JP); Tadasu Taniguchi, Nara (JP); Masahiko Fujita, Nara (JP); Yasuhiro Takai, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/822,628

(22) Filed: Jul. 9, 2007

(30) Foreign Application Priority Data
Jul. 10, 2006 (JP) 2006-189213

(51) Int. Cl. G03G 15/00; B65H 31/00

(52) U.S. Cl. 271/207

(57) ABSTRACT

An ejection sheet stacker includes a sheet ejection tray on which ejected sheets are stacked, and an indicator which indicates the amount of sheets stacked on the sheet ejection tray. With this arrangement, a user can easily check the amount of sheets stacked on the sheet ejection tray.

### CROSS-REFERENCE TO RELATED APPLICATIONS

This application is related to Japanese patent application No. 2006-189213 filed on Jul. 10, 2006, whose priority is claimed under 35 USC § 119, the disclosure of which is incorporated by reference in its entirety.

### BACKGROUND OF THE INVENTION

1. Field of the Invention

The present invention relates to an ejection sheet stacker on which sheets formed with an image by an image forming apparatus, for example, are stacked.

2. Description of the Related Art

Known as a prior art related to the present invention is a sheet cassette which includes an indication needle provided on a bottom plate of a sheet cassette biased by a spring and vertically movable together with the bottom plate for indicating the amount of sheets remaining in the sheet cassette (see, for example, Japanese Unexamined Patent Publication No. HEI4(1992)-243742).

Image forming apparatuses such as copying machines have been prevailing in the market for many years. Various functions and capabilities of the apparatuses ranging from basic performance such as printing speed and printing quality to usability have been continuously improved since the advent of the image forming apparatuses.

Among others, the print processing speed has recently been increased drastically, and apparatuses having a near-print level printing speed on the order of 100 or more sheets per minute have been developed.

To cope with the increase in the print processing speed, higher performance print processing mechanisms and fixing mechanisms have been developed, and post-processing mechanisms for stapling, punching, interleaving, binding and the like have been developed as well for improvement of user convenience.

Although the print processing mechanisms, the fixing mechanisms and the post-processing mechanisms thus have higher performance, little attention has been paid to the handling of ejected sheets, which hence requires improvement.

More specifically, the number of sheets to be stored in a single sheet cassette has recently been increased from 250 to 500 or 1,000 for performing a printing process at a higher print processing speed without interrupting a user's printing request.

Even with the increase in the capacity of the sheet cassette for higher-speed and large-volume printing, the image forming apparatuses are adapted to interrupt the printing process for prevention of sheet jamming upon detection of a full state of a sheet ejection tray by a full detection sensor provided in the vicinity of a sheet ejection port when the sheet ejection tray is filled with ejected sheets during the printing process.

To prevent the interruption of the printing process due to the full state of the sheet ejection tray, a user should preliminarily check the amount of the sheets ejected on the sheet ejection tray and empirically judge whether there is a possibility of the interruption of the user's printing request.

### SUMMARY OF THE INVENTION

In view of the foregoing, the present invention provides an ejection sheet stacker which permits a user to easily check the amount of sheets ejected on a sheet ejection tray.

The present invention provides an ejection sheet stacker comprising a sheet ejection tray on which ejected sheets are stacked, and an indicator which indicates the amount of the sheets stacked on the sheet ejection tray.

According to the present invention, the indicator is provided for indicating the amount of the sheets stacked on the sheet ejection tray. Therefore, the user can easily and assuredly check the amount of the sheets stacked on the sheet ejection tray with reference to the indicator without relying on a user's empirical judgment based on unclear criteria.

### BRIEF DESCRIPTION OF THE DRAWINGS

FIG. 1 is a diagram showing the overall construction of an image forming apparatus including an ejection sheet stacker according to an embodiment of the present invention.

FIG. 2 is an enlarged view of a major portion shown in FIG. 1.

FIG. 3 is a diagram for explaining an exemplary indicator provided in the ejection sheet stacker.

FIG. 4 is a flow chart showing a printing process to be performed by the image forming apparatus.

### DESCRIPTION OF THE PREFERRED EMBODIMENTS

An ejection sheet stacker according to the present invention includes a sheet ejection tray on which ejected sheets are stacked, and an indicator which indicates the amount of sheets stacked on the sheet ejection tray.

The inventive ejection sheet stacker may be used, for example, for receiving sheets ejected from an image forming apparatus.

The term “image forming apparatus” herein means an apparatus, such as a copying machine, a facsimile machine, a printing machine or a complex machine functioning as two or more of these machines, which is adapted to form an image on a sheet.

The type of the sheet is not particularly limited, as long as an image can be formed on the sheet by the image forming apparatus. Examples of the sheet include recording sheets of paper such as copy sheets and post cards, and recording sheets of a material other than paper such as OHP sheets.

The shape and material of the sheet ejection tray are not particularly limited, as long as the ejected sheets can be stacked thereon.

The term “indicator” herein means a component capable of indicating the amount of the sheets stacked on the sheet ejection tray. The shape and design of the indicator are not particularly limited. The indicator includes, for example, a scale and numerals affixed to the scale.

In the inventive ejection sheet stacker, the sheet amount indicated by the indicator may be the amount of sheets further stackable to a maximum stacking amount of the sheet ejection tray.

With this arrangement, the user can easily check the stackable sheet amount, i.e., the number of stackable sheets, simply by checking the indicator and the sheets stacked on the sheet ejection tray. Thus, where the ejection sheet stacker having the aforesaid construction is provided in the image forming apparatus, for example, the user can easily check whether or not the number of sheets to be printed according to a user's printing request is accommodated within the stackable sheet number. If the sheet number according to the printing request is likely to exceed the stackable sheet number, the user removes sheets currently stacked on the sheet ejection tray, whereby the interruption of the printing process can be prevented which may otherwise occur due to the full state of the sheet ejection tray.

The inventive ejection sheet stacker may further include an alignment reference plate which aligns the ejected sheets in abutment against the sheets, and the indicator may be provided on the alignment reference plate.

With this arrangement, the ejected sheets are neatly stacked without scattering, and the indicator is partly hidden by the neatly stacked sheets. Therefore, the user can easily and accurately check the amount of the sheets stacked on the sheet ejection tray.

The term “alignment reference plate” herein means a plate component which aligns at least one-side edges of the sheets so that the sheets can be neatly stacked. As long as this purpose is attained, the shape, material and position of the alignment reference plate are not particularly limited. Where the ejection sheet stacker having the aforesaid construction is provided in the image forming apparatus, for example, the alignment reference plate may be provided on an external panel of the image forming apparatus having a sheet ejection port. In this case, the external panel of the image forming apparatus may partly double as the alignment reference plate.

In the inventive ejection sheet stacker, the indicator may include a plurality of scales provided in different positions thereof for checking a warped state of the stacked sheets.

With this arrangement, the scales are provided in the different positions of the indicator. Even if the sheets to be stacked on the tray are warped due to heat applied thereto in a fixing step in the image forming apparatus, it is possible to check the amount of the stacked sheets according to the warped state of the sheets.

The inventive ejection sheet stacker may further include a detection sensor which detects that the amount of the stacked sheets reaches a predetermined stacking amount, and the maximum stacking amount may be set at a level not greater than the predetermined stacking amount on the indicator.

With this arrangement, the maximum stacking amount indicated to the user by the indicator is not greater than the predetermined staking amount at which the detection sensor is actuated. In other words, the detection sensor is not actuated even if the ejected sheets are stacked to the maximum stacking amount.

Where the ejection sheet stacker having the aforesaid construction is provided in the image forming apparatus, for example, there is no possibility that the printing process performed by the image forming apparatus is interrupted in response to the detection by the detection sensor when the ejected sheets are stacked to the maximum stacking amount.

In the inventive ejection sheet stacker, the indicator may include indications for plural types of sheets having different thicknesses.

With this arrangement, the user can check the stacked sheet amount for the plural types of sheets having different thicknesses.

For example, an ordinary sheet may have a thickness of 100 μm to 120 μm or 130 μm, and a thicker sheet such as a post card may have a thickness of about 200 μm to about 250 μm.

The indicator may include plural types of indications having scales with different line thicknesses and numerals of different fonts or having different colors.

According to another aspect of the present invention, there is provided an image forming apparatus including an image forming section which forms an image on a sheet and ejects the sheet, and an ejection sheet stacker on which ejected sheets are stacked, wherein the ejection sheet stacker is the aforementioned inventive ejection sheet stacker.

In the image forming apparatus, the amount of sheets ejected from the image forming section and stacked on the sheet ejection tray is accurately indicated to the user. This improves the user convenience.

### Embodiments

The present invention will hereinafter be described in detail by way of embodiments thereof with reference to the attached drawings.

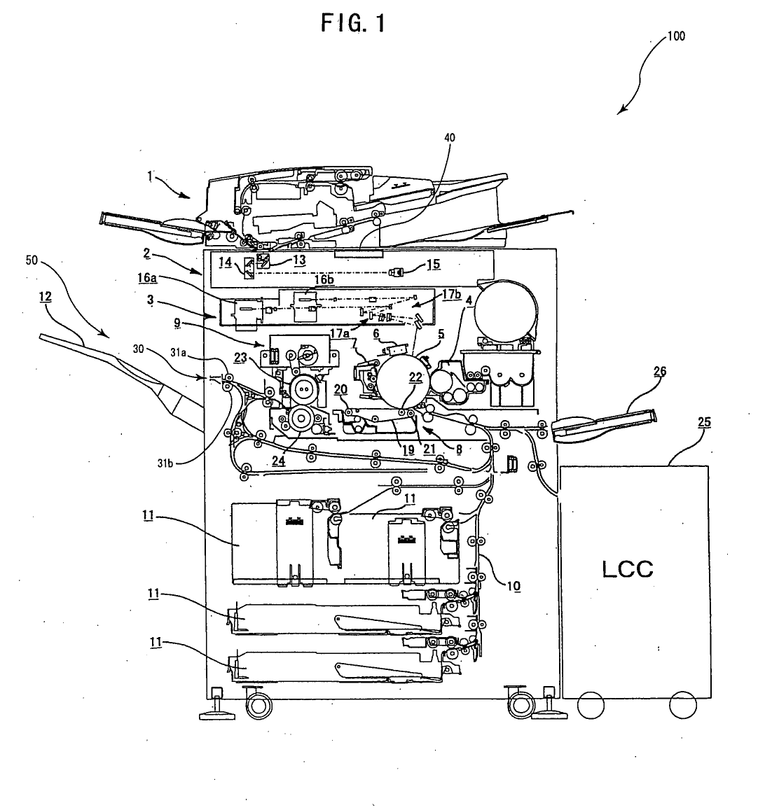

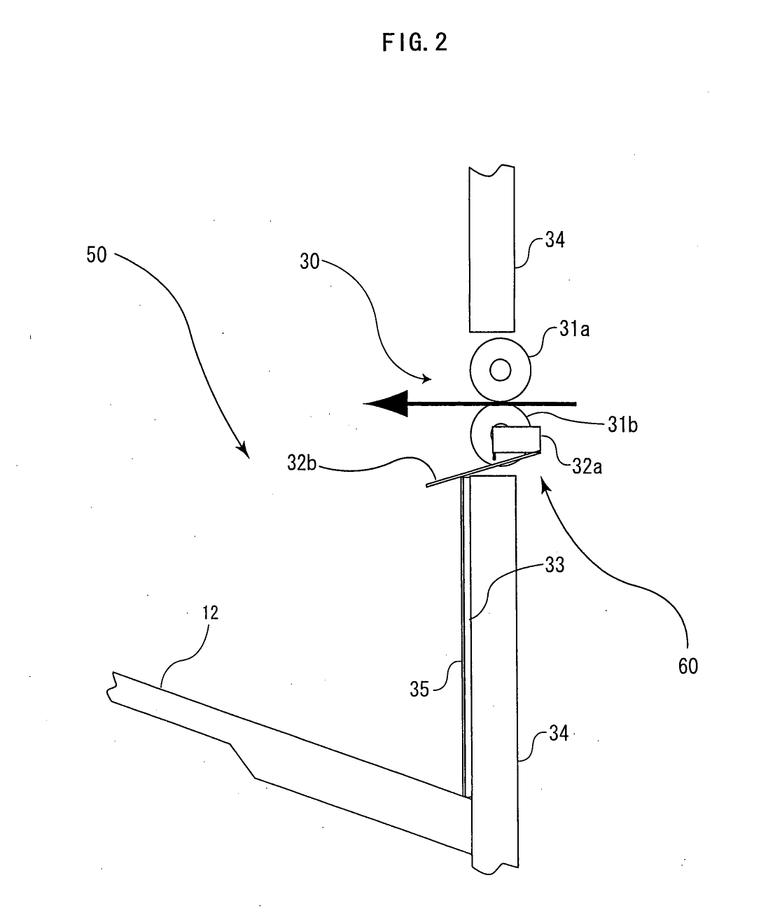

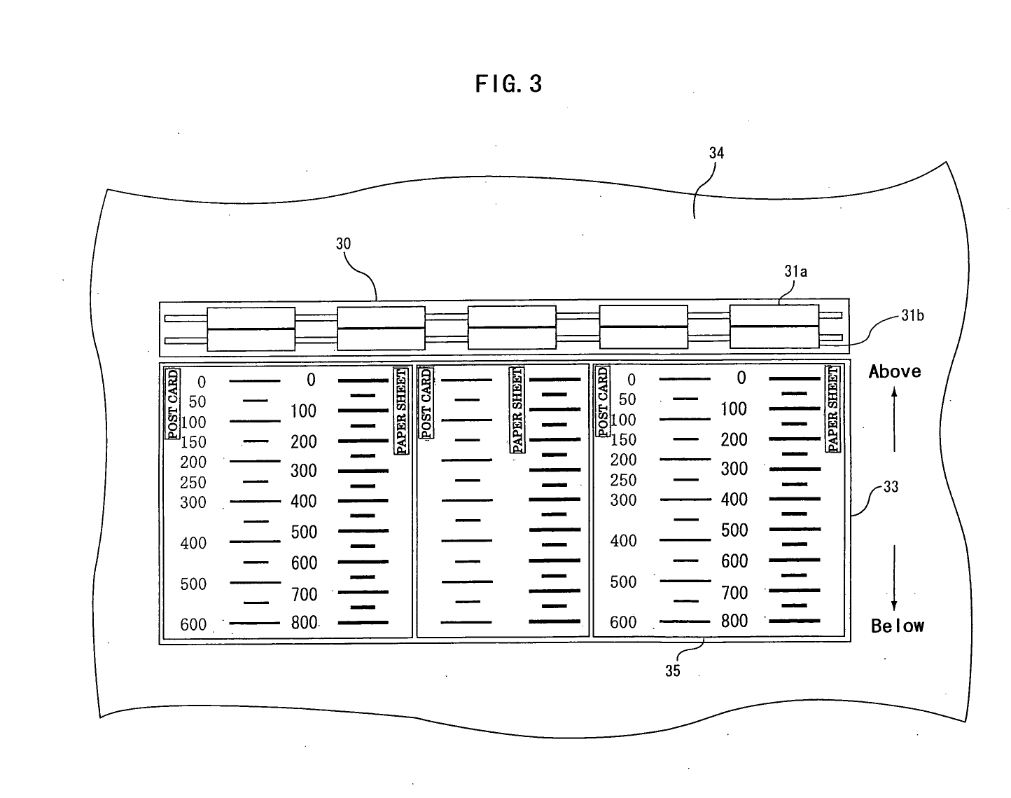

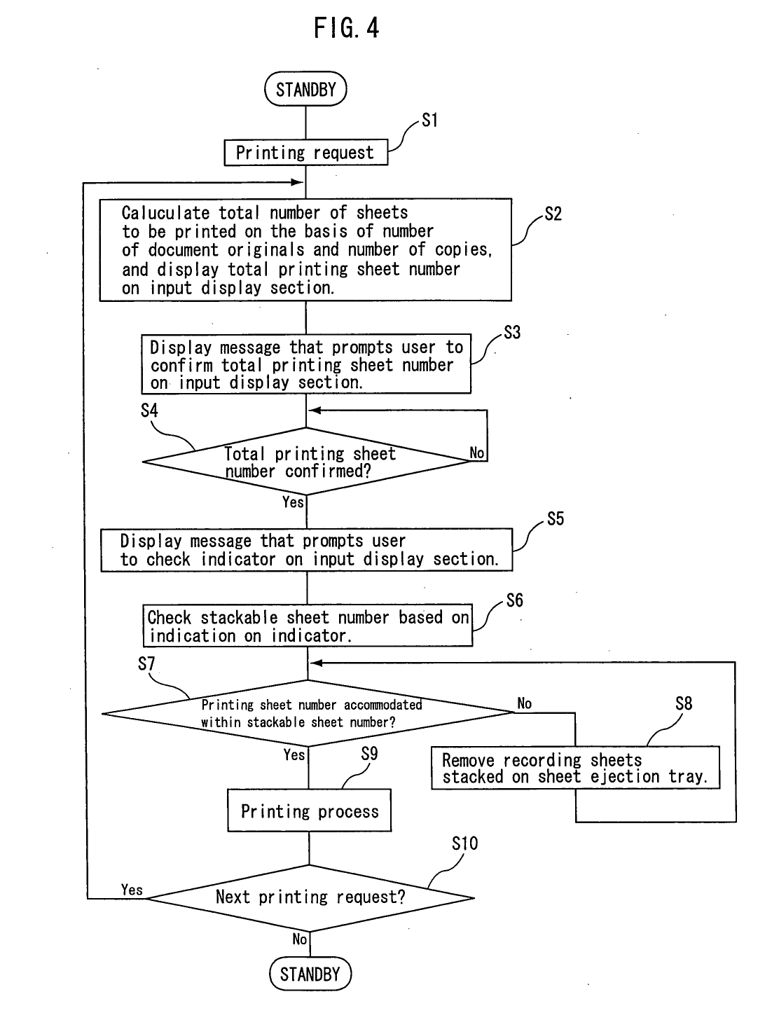

FIG. 1 is a diagram showing the overall construction of an image forming apparatus including an ejection sheet stacker according to an embodiment of the present invention. FIG. 2 is an enlarged view of a major portion shown in FIG. 1. FIG. 3 is a diagram for explaining an exemplary indicator provided in the ejection sheet stacker. FIG. 4 is a flow chart showing a printing process to be performed by the image forming apparatus.

### Overall Construction and Operation of Image Forming Apparatus

An image forming apparatus 100 shown in FIG. 1 includes an automatic document feeder (ADF) 1, an image reading section 2, an optical writing unit 3, a developing unit 4, a photoreceptor 5, an electrifier 6, a cleaner unit 7, a transfer unit 8, a fixing unit 9, a sheet transport path 10, a sheet feeding section 11, and an ejection sheet stacker 50 including a sheet ejection tray 12.

The image reading section 2 principally includes a light source holder 13, a mirror set 14 and a CCD 15.

Where a document original fed from the automatic document feeder 1 is to be scanned, the scanning of an image of the document original is achieved with the optical source holder 13 and the mirror set 14 kept still.

When the document original is transported from the automatic document feeder 1, the document original is irradiated with light emitted from a light source of the light source holder 13, and light reflected from the document original is deflected by the mirror set 14 to be focused on the CCD 15 and converted into electronic image data.

The electrifier 6 is electrical charging means for electrically uniformly charging the surface of the photoreceptor 5 at a predetermined potential. In the image forming apparatus 100 according to this embodiment, a charger-type electrifier is employed as the electrifier 6, but a roller or brush electrifier of a contact type may also be employed. Used as the optical writing unit 3 is a laser scanning unit (LSU) which includes laser emitting members 16a, 16b and mirror sets 17a, 17b.

The optical writing unit 3 is of a dual beam system including two laser emitting members 16a, 16b for higher speed printing process. Thus, a load associated with higher speed irradiation is reduced.

The surface of the photoreceptor 5 uniformly charged by the electrifier 6 is exposed to laser beams applied thereto from the laser emitting members 16a, 16b according to the inputted image data via the mirror sets 17a, 17b, whereby an electrostatic latent image is formed on the surface of the photoreceptor 5 according to the image data.

The developing unit 4, which is provided in the vicinity of the photoreceptor 5, develops the electrostatic latent image formed on the surface of the photoreceptor 5 with a black toner.

The cleaner unit 7, which is provided in the vicinity of the photoreceptor 5, removes toner remaining on the surface of the photoreceptor 5 after the development and image transfer, and recovers the removed toner.

The image forming apparatus 100 further includes a control section (not shown) which controls the overall operation of the image forming apparatus 100.

The control section includes a CPU, a ROM which stores control programs to be executed by the CPU, a RAM which provides a work area for the CPU, a nonvolatile memory which retains control data, an input circuit to which a signal is inputted from detection means of the image forming apparatus 100, a driver circuit which drives actuators and motors for actuating drive mechanisms of the image forming apparatus 100, and an output circuit which drives the laser emitting members 16a, 16b.

The image forming apparatus 100 further includes an input display section 40 which functions as an input section and a display section. Thus, the user can input a command related to a printing request including the number of sheets per copy to be printed and the number of copies via the input display section 40. Further, the user can obtain information including warnings and messages outputted from the image forming apparatus 100 via the input display section 40.

A toner image formed on the surface of the photoreceptor 5 by developing the electrostatic latent image in the aforesaid manner is transferred onto a recording sheet by applying an electric field having a polarity opposite to that of the charges of the electrostatic latent image from the transfer unit 8.

Where the electrostatic latent image has a negative polarity, for example, the electric field applied by the transfer unit 8 has a positive polarity.

A transfer belt 19 of the transfer unit 8 is stretched around a driving roller 20, a driven roller 21 and other rollers, and has a predetermined resistivity (e.g., 1×10⁹ to 1×10¹³ Ω·cm).

An electrically conductive elastic roller 22 capable of applying the transfer electric field is disposed at a contact between the photoreceptor 5 and the transfer belt 19.

The recording sheet with the toner image (unfixed toner) transferred thereon by the transfer unit 8 is transported through the fixing unit 9, whereby the toner image is melted and fixed on the recording sheet.

The fixing unit 9 includes a heat roller 23 and a press roller 24. The heat roller 23 includes a heat source provided on an inner peripheral surface thereof for keeping the surface of the heat roller 23 at a predetermined temperature (a fixing temperature of about 160° C. to about 200° C.).

On the other hand, the press roller 24 includes press members (not shown) provided on opposite ends thereof for pressing the press roller 24 against the heat roller 23 at a predetermined pressure.

Thus, the unfixed toner on the transported recording sheet is heated to be melted by the heat roller 23 in a press contact portion (a so-called fixing nip) between the heat roller 23 and the press roller 24, and pressed against the recording sheet to be fixed on the recording sheet in the press contact portion.

A plurality of sheet cassettes of the sheet feeding section 11 which store recording sheets to be used for image formation are provided in a lower portion of the image forming apparatus 100 according to this embodiment.

Since the image forming apparatus 100 according to this embodiment is adapted for high speed printing process, the sheet cassettes 11 are each capable of containing 500 to 1500 recording sheets of a regular size.

Further, a large capacity sheet cassette (LCC) 25 capable of containing several types of recording sheets in great amounts and a manual feed tray 26 to be mainly used for printing on a sheet of an irregular size are provided on a lateral side of the image forming apparatus 100.

The sheet ejection tray 12 is disposed on a lateral side of the apparatus opposite from the manual feed tray 26. A recording sheet subjected to the printing process is ejected onto the sheet ejection tray 12 from a sheet ejection port 30 via sheet ejection rollers 31a, 31b.

### Construction of Ejection Sheet Stacker

FIG. 2 is an enlarged view of a major portion of the image forming apparatus 100 shown in FIG. 1, schematically illustrating the construction of the ejection sheet stacker 50 according to the embodiment of the present invention.

As shown in FIG. 2, the ejection sheet stacker 50 principally includes the sheet ejection tray 12 on which recording sheets subjected to the printing process and ejected from the sheet ejection port 30 of the image forming apparatus 100 (see FIG. 1) are stacked, and an indicator 35 which indicates the amount of the recording sheets stacked on the sheet ejection tray 12.

The indicator 35 is provided on an alignment reference plate 33 attached to an external panel 34 of the image forming apparatus 100.

The alignment reference plate 33 is disposed below the sheet ejection port 30. On the other hand, the sheet ejection tray 12 is inclined so that trailing edges of recording sheets ejected down onto the sheet ejection tray 12 from the sheet ejection port 30 via the sheet ejection rollers 31a, 31b are brought into abutment against the alignment reference plate 33 by gravity.

Thus, the trailing edges of the recording sheets sequentially ejected from the sheet ejection port 30 are successively brought into abutment against the alignment reference plate 33, so that the recording sheets are stacked on the sheet ejection tray 12 in a neatly aligned manner.

A full detection sensor 60 including a micro-switch 32a and an actuation piece 32b which actuates the micro-switch 32a is provided in the vicinity of the sheet ejection port 30 for detecting a full state of the sheet ejection tray 12.

When the sheet ejection tray 12 becomes full of the sequentially ejected recording sheets, the actuation piece 32b of the full detection sensor 60 is pushed up by the recording sheets stacked on the sheet ejection tray 12 to actuate the micro-switch 32a.

Upon the detection of the full state of the sheet ejection tray 12 by the full detection sensor 60, the control section of the image forming apparatus 100 interrupts the printing process to prevent a sheet jam in the sheet ejection port 30, and causes the input display section 40 of the image forming apparatus 100 to display a message that prompts a user to remove the printed recording sheets from the sheet ejection tray 12.

However, the interruption of the printing process upon the actuation of the full detection sensor 60 is not preferred for the user, because a printing request applied to the image forming apparatus 100 by the user (i.e., a printing job) is interrupted.

In the ejection sheet stacker 50 according to this embodiment, as described above, the indicator 35 is provided on the alignment reference plate 33 provided below the sheet ejection port 30. Therefore, the user can easily check the amount of the recording sheets stacked on the sheet ejection tray 12.

More specifically, as shown in FIG. 3, the indicator 35 vertically extends from a bottom of the sheet ejection tray 12 to a position slightly lower than a sensing position of the full detection sensor 60 (see FIG. 2) provided in the vicinity of the sheet ejection port 30. The indicator 35 includes a plurality of scales arranged laterally of the indicator 35 alongside the sheet ejection port 30.

When the recording sheets are stacked on the sheet ejection tray 12, the scales and numerals of the indicator 35 are partly hidden by the stacked recording sheets and invisible from the user. Therefore, the scales of the indicator 35 are designed so that the numerals are arranged in a decreasing order in a direction from the bottom of the sheet ejection tray 12 to the vicinity of the sensing position of the full detection sensor 60. That is, the indicator 35 indicates the number of sheets further stackable on the sheet ejection tray 12. Where a relatively great amount of recording sheets printed according to another user's printing request are already stacked on the sheet ejection tray 12 and the uppermost one of the recording sheets is located at “200” on a scale of an ordinary sheet indication of the indicator 35, for example, the user finds that about 200 ordinary sheets can be further printed.

The indicator 35 includes two types of indications each including a scale and numerals for two types of sheets having different sheet thicknesses, i.e., for ordinary sheets and post cards. Where the uppermost one of the stacked sheets is located at “200” on the scale of the ordinary sheet indication as described above, for example, the user finds that about 200 ordinary sheets or about 150 post cards can be further printed.

The ordinary sheet indication and the post card indication include scales having different line thicknesses and numerals of different fonts for easy discrimination therebetween.

The printed sheets are often warped due to the heat applied thereto in the fixing step. In such a case, the uppermost one of the stacked sheets is not flat but warped. To cope with this, the plurality of indications of the indicator 35 each including a scale and numerals are arranged alongside the sheet ejection port 30 as described above. Therefore, even if the sheets are stacked in a warped state, the user can recognize a further printable sheet number from a scale position and a numeral at which the uppermost one of the stacked sheets is located.

Next, a preferred printing process to be performed with effective use of the image forming apparatus 100 including the ejection sheet stacker 50 according to the embodiment of the present invention will be described with reference to the flow chart shown in FIG. 4. In the following description, components corresponding to those shown in FIGS. 1, 2 and 3 will be denoted by the same reference characters as in FIGS. 1, 2 and 3, and reference will be made to FIGS. 1, 2 and 3 if necessary.

As shown in FIG. 4, a user inputs a printing request from the input display section 40 of the image forming apparatus 100 in a standby state in Step 1. The printing request herein means a request applied for causing the image forming apparatus 100 to perform the printing process by inputting the size of sheets, the number of sheets per copy and the number of copies desired to be printed.

The image forming apparatus 100 which receives the printing request in Step 1 calculates the total number of sheets to be printed on the basis of the number of sheets per copy and the number of copies inputted by the user, and displays the total printing sheet number on the input display section 40 (Step 2).

In turn, the image forming apparatus 100 causes the input display section 40 to display a message that prompts the user to confirm the total printing sheet number displayed in Step 2 (Step 3).

The user prompted to confirm the total printing sheet number in Step 3 confirms the total printing sheet number of the print job requested by the user, and inputs confirmation from the input display section 40 (Step 4).

Upon the input of the confirmation by the user in Step 4, the image forming apparatus 100 causes the input display section 40 to display a message that prompts the user to check the indication (the scale and the numerals) of the indicator 35 (Step 5).

The user prompted to check the indication in Step 5 sees the indication of the indicator 35 and checks a stackable sheet number (Step 6).

The user who checks the stackable sheet number in Step 6 judges whether or not the number of sheets to be printed according to the user's print request is accommodated within the stackable sheet number (Step 7).

If the user judges in Step 7 that the number of sheets to be printed according to the user's print request exceeds the stackable sheet number, the user removes recording sheets currently stacked on the sheet ejection tray 12 (Step 8).

If the user judges in Step 7 that the number of sheets to be printed according to the user's print request is accommodated within the stackable sheet number, on the other hand, the user inputs this judgment via the input display section 40 and, in response thereto, the image forming apparatus 100 starts performing the printing process (Step 9).

Upon completion of the printing process in Step 9, the image forming apparatus 100 judges in Step 10 whether there is a next printing request. If the next printing request is present, the routine returns to Step 2. If there is no next printing request, the image forming apparatus 100 goes into the standby state and ends the printing process.

With the use of the image forming apparatus 100 including the ejection sheet stacker 50 according to the embodiment of the present invention, as described above, the user can easily judge from the indicator 35 whether or not the number of sheets to be printed according to the user's print request is accommodated within the stackable sheet number. Thus, the user can prevent the interruption of the requested printing job which may otherwise occur due to the full state of the sheet ejection tray 12. This improves the user convenience.

Although the alignment reference plate 33 is separately provided on the external panel 34 of the image forming apparatus 100 in the embodiment described above, the external panel 34 of the image forming apparatus 100 may partly double as the alignment reference plate 33.

In the printing process described above, the message that prompts the user to check the indicator 35 is displayed irrespective of the number of sheets to be printed and the amount of the sheets stacked on the sheet ejection tray 12. Alternatively, the control section may be adapted to monitor the amount of the sheets stacked on the sheet ejection tray 12 by an optical sensor or a like sensor provided on the alignment reference plate 33 and display the message that prompts the user to check the indicator 35 only when it is judged that the number of sheets to be printed possibly exceeds the stackable sheet number.

What is claimed is:

1. An ejection sheet stacker comprising:
a sheet ejection tray on which ejected sheets are stacked; and
an indicator which indicates an amount of sheets stacked on the sheet ejection tray.

2. An ejection sheet stacker as set forth in claim 1, wherein the sheet amount indicated by the indicator is an amount of sheets further stackable to a maximum stacking amount of the sheet ejection tray.

3. An ejection sheet stacker as set forth in claim 1, further comprising an alignment reference plate which aligns the ejected sheets in abutment against the sheets,
wherein the indicator is provided on the alignment reference plate.

4. An ejection sheet stacker as set forth in claim 1, wherein the indicator includes a plurality of scales provided in different positions thereof for checking a warped state of the stacked sheets.

5. An ejection sheet stacker as set forth in claim 2, further comprising a detection sensor which detects that the amount of the stacked sheets reaches a predetermined stacking amount,
wherein the maximum stacking amount is set at a level not greater than the predetermined stacking amount on the indicator.

6. An ejection sheet stacker as set forth in claim 1, wherein the indicator includes indications for plural types of sheets having different thicknesses.

7. An image forming apparatus comprising:
an image forming section which forms an image on a sheet and ejects the sheet; and
an ejection sheet stacker on which ejected sheets are stacked;
wherein the ejection sheet stacker is an ejection sheet stacker as recited in claim 1.
